(19) United States
(12) Patent Application Publication
(10) Pub. No.: US 2014/0160579 A1
(43) Pub. Date: Jun. 12, 2014

(54) VARIABLE FOCUS FLEXIBLE LENS ASSEMBLY

(71) Applicant: Kuei-Wei LIN, Taichung (TW)

(72) Inventor: Kuei-Wei LIN, Taichung (TW)

(21) Appl. No.: 13/707,569

(22) Filed: Dec. 6, 2012

(51) Int. Cl. G02B 3/14

(52) U.S. Cl. CPC G02B 3/14
USPC 359/666

(57) ABSTRACT

A variable focus flexible lens assembly is disclosed. The assembly comprises a first lens module, the first flexible film is fixed at one side of the first ring body longitudinally; a partition plate, disposed at one side of the first ring body of the first lens module far away from the first flexible film; and a second lens module, the second flexible film is fixed at one side of the second ring body far away from the partition plate longitudinally. The pressures of the first and second lens modules are controlled by a first and a second pressure control units respectively, and further the curvatures of the first and second flexible films are also controlled respectively.

### FIELD OF THE INVENTION

The present invention relates to a variable focus flexible lens assembly.

### BACKGROUND OF THE INVENTION

In the past, the variable focus lens mounted in the camera is widely-known technology. The conventional variable focus lens mounted in the camera is arranged a motor to drive at least two lenses to adjust the distance therebetween, and then to achieve the effect of varying the focus.

The conventional variable focus lens has following problems.

The first problem is that the volume of the lens becomes larger. The conventional variable focus lens is hard type and not able to be flexible. The method is to adjust the distance between two lenses and the focus which is varied is limited. However, it can add more lenses to improve the effect of varying focus, but the volume of the lens and cost are increased. Therefore, the larger the volume of the lens is, the more expensive the camera is.

The second problem is that it is hard to be manufactured. Although it can improve the effect of varying focus by adding more lenses, it is hard to arrange several lenses and driving assemblies for driving those lenses in the limited space.

The third problem is that the effect of varying focus becomes worse. To vary focus of the conventional camera in large range, a plural lenses needs to be moved simultaneously. And the conventional variable focus is mechanical driving resulting in limited speed of varying focus, that is, it is not able to vary focus quickly. Therefore, the effect of varying focus becomes worse.

The fourth problem is low variability of use. The conventional focus lens is constituted of several lenses and motors. It is not able to have high variability of use because the elements are complicated.

Please reference to TW publication patent No. 200813486, which is disclosed a hybrid variable focus device. The device comprises a first lens portion having a first connection part; a second lens portion having a second connection part for connecting to the first connection part of the first lens portion, the first and second lens portions are flexible and in the coaxial line; and a cavity disposed between the first and second lens portions for accommodating a light-transmitting fluid. One of the first and the second lens portions is pressed/released to be deformed and changes the curvature by change the pressure of the fluid so as to improve the problem of large volume. However, one of the first and second lens portions is controlled by a single control portion and the cavity is disposed between the first and second lens portions and accommodating the light-transmitting fluid. The precision of changing curvature of each lens portions is limited.

Please reference to U.S. Pat. No. 2,300,251 (described hereafter '251), which is disclosed a variable focus lens. Please refer to FIG. 2 and FIG. 6 of the patent '251, it is only disclosed that a single screw to control the hydraulic pressure (or atmospheric pressure) shown as FIG. 2, and separated two fluid channels and still using a single screw to control the hydraulic pressure (or atmospheric pressure) shown as FIG. 6. Therefore, it is not able to achieve the effect of precisely and independently controlling each lens.

For above problems, a variable focus flexible lens assembly is disclosed to overcome them.

### SUMMARY OF THE INVENTION

An objective of this invention is providing a variable focus flexible lens assembly which is with simple structure and capable of varying different focuses to match various equipments.

To achieve above objectives, a variable focus flexible lens assembly is provided, and the device comprising: a first lens module, having a first ring body, a first flexible film, and a first pipe, the first ring body is fluidly communicated with the first pipe, the first flexible film is fixed at one side of the first ring body longitudinally; a partition plate, disposed at one side of the first ring body of the first lens module far away from the first flexible film, the first ring body, the partition plate, and the first flexible film are defined a first accommodation space which is filled with a first fluid; a second lens module, having a second ring body, a second flexible film, and a second pipe, the second ring body is fluidly communicated with the second pipe, one side of the second ring body in longitudinal direction is fixed at one side of the partition plate far away from the first lens module, the second flexible film is fixed at one side of the second ring body far away from the partition plate longitudinally, the second ring body, the partition plate, and the second flexible film are defined a second accommodation space which is filled with a second fluid; a first pressure control unit, connected to the first pipe, the pressure of the first fluid filled in the first accommodation space is controlled by the first pressure control unit independently, and further the curvature of the first flexible film is controlled by the first pressure control unit; and a second pressure control unit, connected to the second pipe, the pressure of the second fluid filled in the second accommodation space is controlled by the second pressure control unit independently, and further the curvature of the second flexible film is controlled by the second pressure control unit.

In some embodiment, the partition is made of a transparent hard material.

In some embodiment, the first flexible film and the second flexible film are made of an elastic transparent material.

In some embodiment, the first fluid and the second fluid are liquid or gas.

In some embodiment, the first fluid and the second fluid are the same material or different materials.

In some embodiment, the first flexible film and the second flexible film are the same material or different materials.

In some embodiment, the first ring body and the second ring body may be with different diameters, and have the same hard material or different hard materials.

In some embodiment, the variable focus flexible lens assembly further comprises a first ring frame and a second ring frame, the first flexible film is fixed between the first ring frame and the first ring body, the second flexible film is fixed between the second ring frame and the second ring body, the first flexible film and the second flexible film are fixed by bolts or adhesives.

The advantages of the variable focus flexible lens assembly are unlimited volume, easy to be manufactured, good effect of varying focus, and high variability of use.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a variable focus flexible lens assembly in accordance with the present invention.

FIG. 2 is an assembly drawing of the variable focus flexible lens assembly in accordance with the present invention.

FIG. 3 is a sectional drawing of a flowing fluid while forming a convex-convex lens structure of the variable focus flexible lens assembly in accordance with the present invention.

FIG. 4 is a sectional drawing of a flowing fluid while forming a flat-convex lens structure of the variable focus flexible lens assembly in accordance with the present invention.

FIG. 5 is a sectional drawing of a flowing fluid while forming a concave-convex lens structure of the variable focus flexible lens assembly in accordance with the present invention.

FIG. 6 is a sectional drawing of a flowing fluid while forming a convex-flat lens structure of the variable focus flexible lens assembly in accordance with the present invention.

FIG. 7 is a sectional drawing of a flowing fluid while forming a flat-flat lens structure of the variable focus flexible lens assembly in accordance with the present invention.

FIG. 8 is a sectional drawing of a flowing fluid while forming a concave-flat lens structure of the variable focus flexible lens assembly in accordance with the present invention.

FIG. 9 is a sectional drawing of a flowing fluid while forming a convex-concave lens structure of the variable focus flexible lens assembly in accordance with the present invention.

FIG. 10 is a sectional drawing of a flowing fluid while forming a flat-concave lens structure of the variable focus flexible lens assembly in accordance with the present invention.

FIG. 11 is a sectional drawing of a flowing fluid while forming a concave-concave lens structure of the variable focus flexible lens assembly in accordance with the present invention.

### DESCRIPTION OF THE PREFERRED EMBODIMENT

Referring now to the drawings where like characteristics and features among the various figures are denoted by like reference characters.

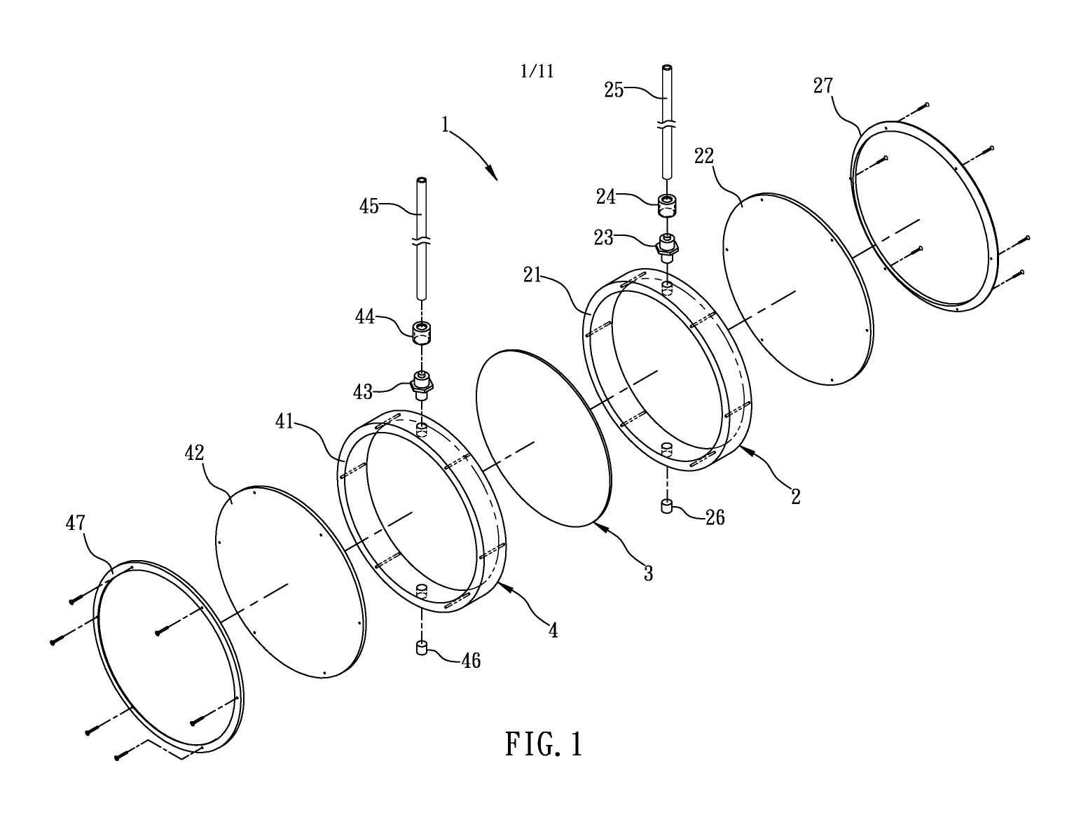

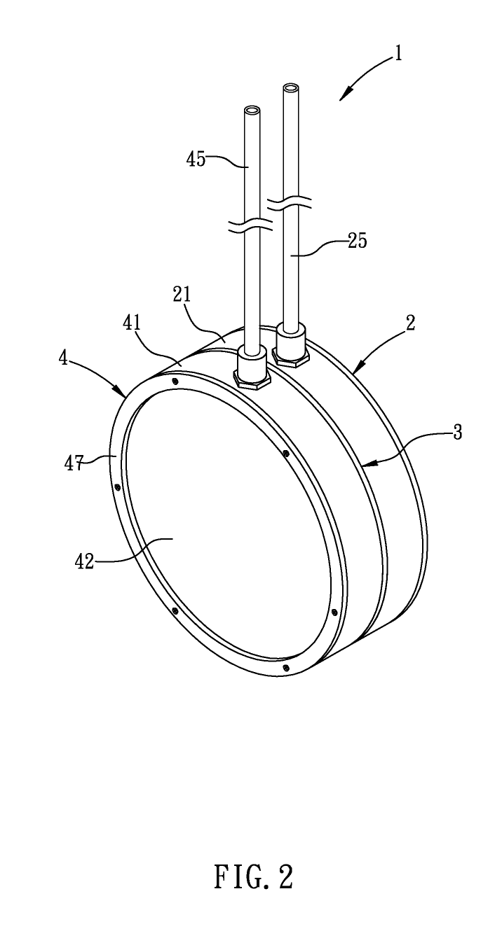

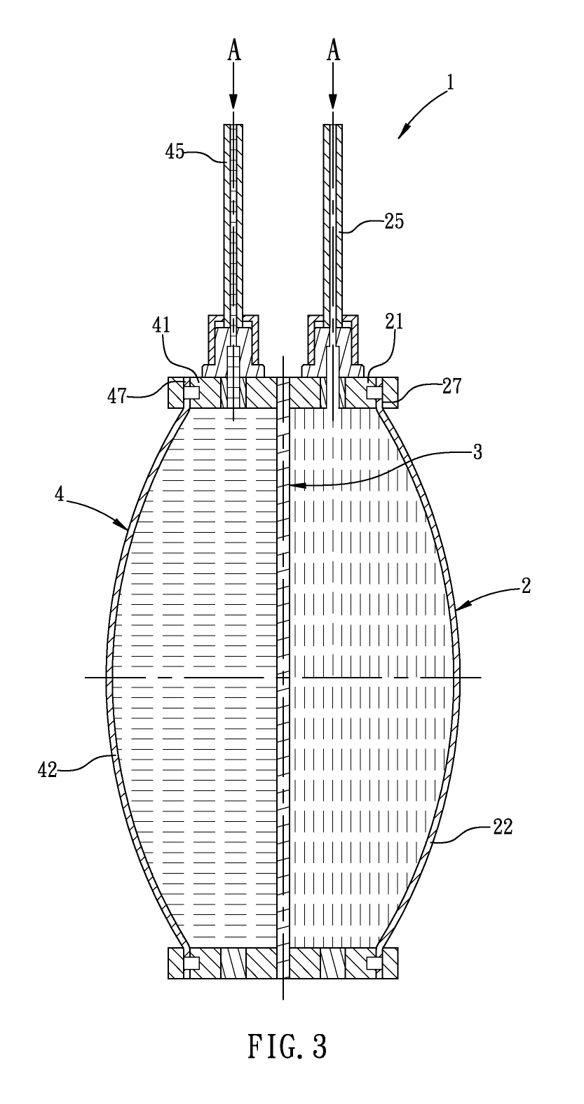

Please refer to FIGS. 1 to 3, wherein FIG. 1 is an exploded view of a variable focus flexible lens assembly in accordance with the present invention, FIG. 2 is an assembly drawing of the variable focus flexible lens assembly in accordance with the present invention, and FIG. 3 is a sectional drawing of a flowing fluid while forming a convex-convex lens structure of the variable focus flexible lens assembly in accordance with the present invention.

The variable focus flexible lens assembly comprises a first lens module 2, a partition plate 3, and a second lens module 4.

The first lens module 2 has a first ring body 21, a first flexible film 22, and a first pipe 25. The first ring body 21 is fluidly communicating with the first pipe 25. The first flexible film 22 is fixed at one side of the first ring body 21 longitudinally. It may use screws or bolts to make the first flexible film 22 be fixed between the first ring frame 27 and the first ring body 21, or the first flexible film 22 may be fixed between the first ring body 21 with an outer screw thread (not shown) and the first ring frame 27 with an inner screw thread by fastening the outer screw thread of the first ring body 21 and the inner screw thread of the first ring frame 27, but there is not limited thereto.

A first accommodation space is defined by the first ring body 21, the partition plate 3, and the first flexible film 22. The accommodation space is filled with a first fluid, and the first fluid may be a liquid (such as water) or gas.

The partition plate 3 is made of a transparent hard material and disposed at one side of the first ring body 21 of the first lens module 2 far away from the first flexible film 22.

The second lens module 4 has a second ring body 41, a second flexible film 42, and a second pipe 45. The second ring body 41 is fluidly communicating with the second pipe 45. One side of the second ring body 41 in longitudinal direction is fixed at one side of the partition plate 3 far away from the first lens module 2. The second flexible film 42 is fixed at one side of the second ring body 41 longitudinally far away from the partition plate 3. It may use screws or bolts to make the second flexible film 42 be fixed between the second ring frame 47 and the second ring body 41, or the second flexible film 42 may be fixed between the second ring body 41 with an outer screw thread (not shown) and the second ring frame 47 with an inner screw thread by fastening the outer screw thread of the second ring body 41 and the inner screw thread of the second ring frame 47, but there is not limited thereto.

A second accommodation space is defined by the second ring body 41, the partition plate 3, and the second flexible film 42. The second accommodation space is filled with a second fluid, and the second fluid may be a liquid (such as water) or gas. The first and second fluids may be the same material or different materials, such as the first fluid is liquid and the second fluid is gas for different materials, and also such as the first fluid is purified water and the second is glycerol for different materials.

The partition plate 3 is made of a transparent hard material, such as transparent acrylic or glass material. The first flexible film 22 and the second flexible film 42 may be the same material or different materials.

A first pressure control unit (not shown) is connected to the first pipe 25, and a second pressure control unit (not shown) is connected to the second pipe 45. The hydraulic pressure or the atmospheric pressure in the first accommodation space is independently controlled by the first pressure control unit, and further the curvature of the first flexible film 22 is also controlled. The hydraulic pressure or the atmospheric pressure in the second accommodation space is independently controlled by the second pressure control unit, and further the curvature of the second flexible film 42 is also controlled.

In FIG. 3, the first fluid is centralized to the first accommodation space (shown in FIG. 3 of right arrow in direction A) of the first lens module 2 through the first pipe 25 with adding pressure by the first pressure control unit (not shown). The second fluid is centralized to the second accommodation space (shown in FIG. 3 of left arrow in direction A) of the second lens module 4 through the second pipe 45 with adding pressure by the second pressure control unit (not shown). Since the first flexible film 22 and the second flexible film 42 are made of an elastic transparent material, the first lens module 2 may be formed a convex lens structure and the second lens module 4 may be also formed a convex lens structure to become a convex-convex lens structure while adding pressure. The pressures of the first lens module 2 and the second lens module 4 are controlled by the first pressure control unit (not shown) and the second pressure control unit (not shown) respectively, and further the curvatures of the first lens module 2 and the second lens module 4 are also controlled by the first pressure control unit (not shown) and the second pressure control unit (not shown) respectively to vary focuses of each lens module 2, 4.

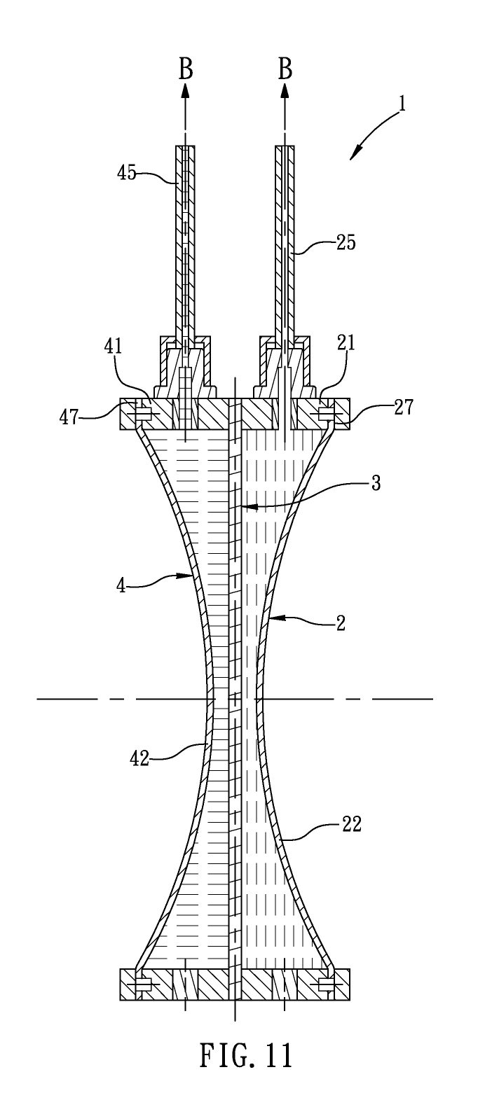

Please refer to FIG. 11, which is a sectional drawing of a flowing fluid while forming a concave-concave lens structure of the variable focus flexible lens assembly in accordance with the present invention. The first fluid is drawn out from the first accommodation space (shown in FIG. 11 of right arrow in direction B) of the first lens module 2 through the first pipe 25 with lowering pressure by the first pressure control unit (not shown). The second fluid is drawn out from the second accommodation space (shown in FIG. 11 of left arrow in direction B) of the second lens module 4 through the second pipe 45 with lowering pressure by the second pressure control unit (not shown). Since the first flexible film 22 and the second flexible film 42 are made of an elastic transparent material, the first lens module 2 may be formed a concave lens structure and the second lens module 4 may be also formed a concave lens structure to become a concave-concave lens structure while lowering pressure. The pressures of the first lens module 2 and the second lens module 4 are controlled by the first pressure control unit (not shown) and the second pressure control unit (not shown) respectively, and further the curvatures of the first lens module 2 and the second lens module 4 are also controlled by the first pressure control unit (not shown) and the second pressure control unit (not shown) respectively to vary focuses of each lens module 2, 4.

The first pressure control unit is locked to the first ring body 21 by a first pipe terminal 23. To prevent the first pipe 25 from sliding, the first pipe terminal cover 24 is further mounted at outside of the first pipe terminal 23. A bolt hole for ventilating is for exhausting a filler which is not the first fluid in the first accommodation space, and further for locking at the first ring body 21 by a first ring body seal plug 26 so as to isolate the first fluid from the outside of the first ring body 21.

The second pressure control unit is locked to the second ring body 41 by a second pipe terminal 43. To prevent the second pipe 45 from sliding, the second pipe terminal cover 44 is further mounted at outside of the second pipe terminal 43. A bolt hole for ventilating is disposed in the second ring body 41 and corresponding to the second pipe terminal 43, and is for exhausting a filler which is not the second fluid in the second accommodation space, and further for locking at the second ring body 41 by a second ring body seal plug 46 so as to isolate the second fluid from the outside of the second ring body 41.

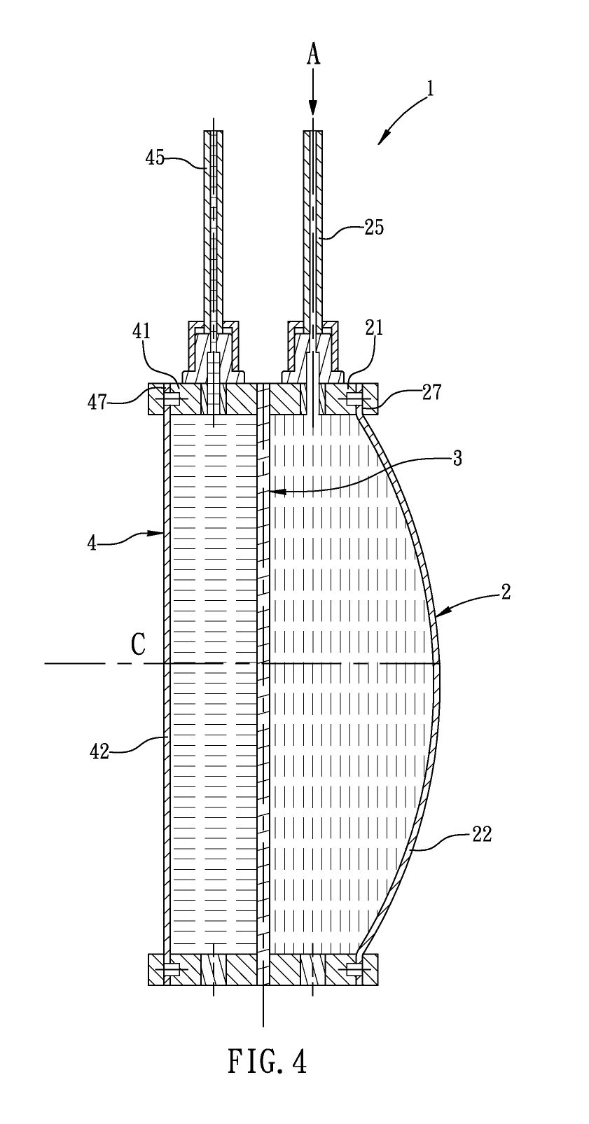

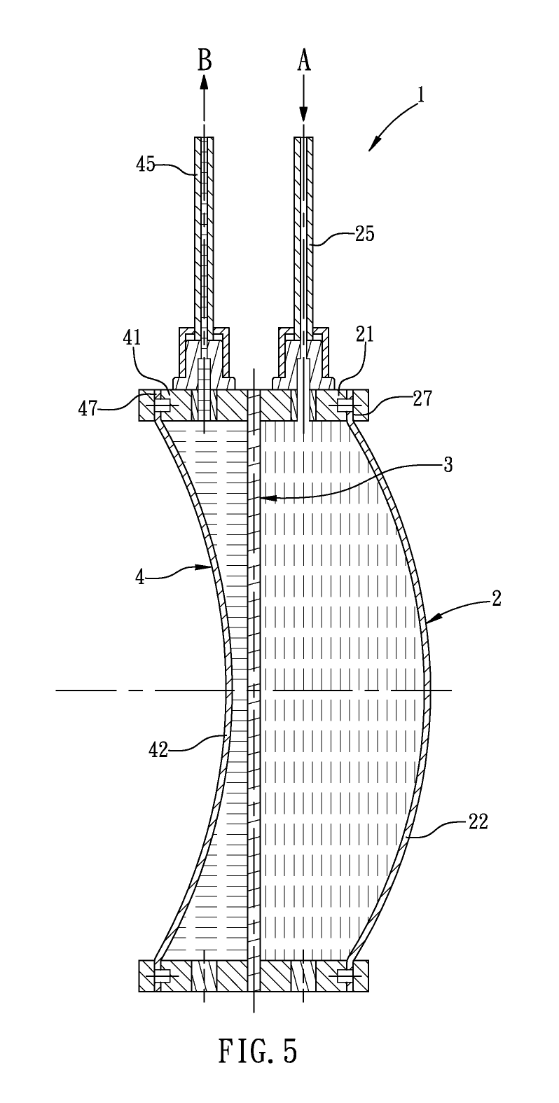

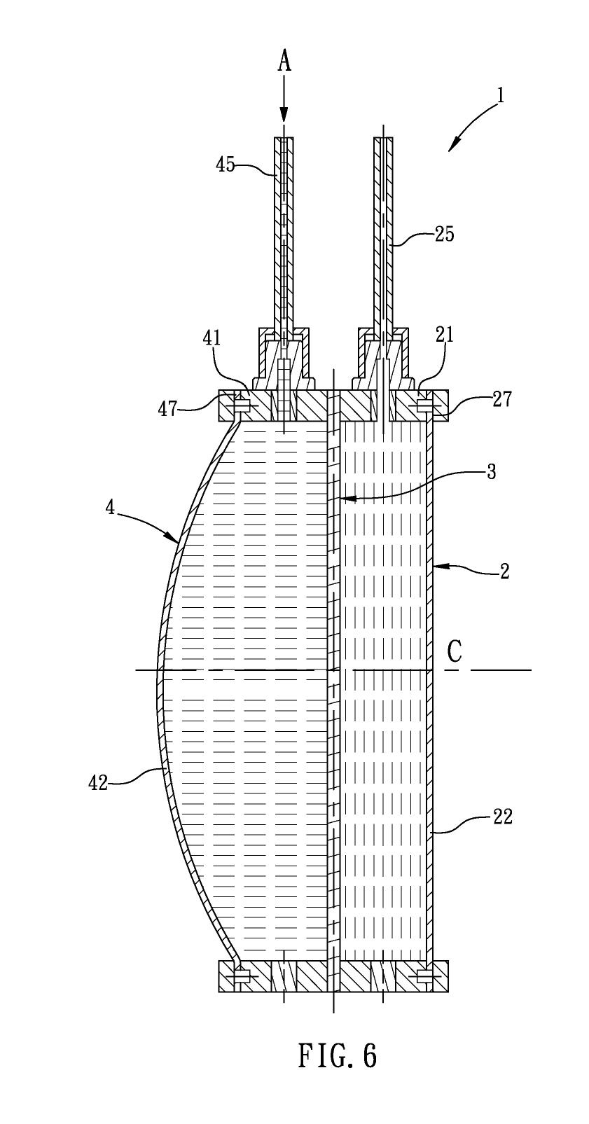

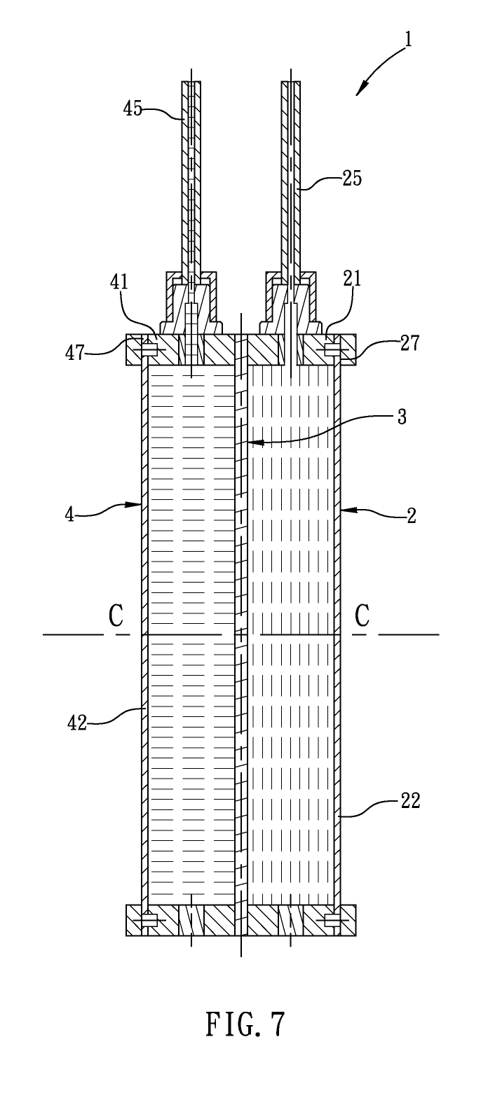

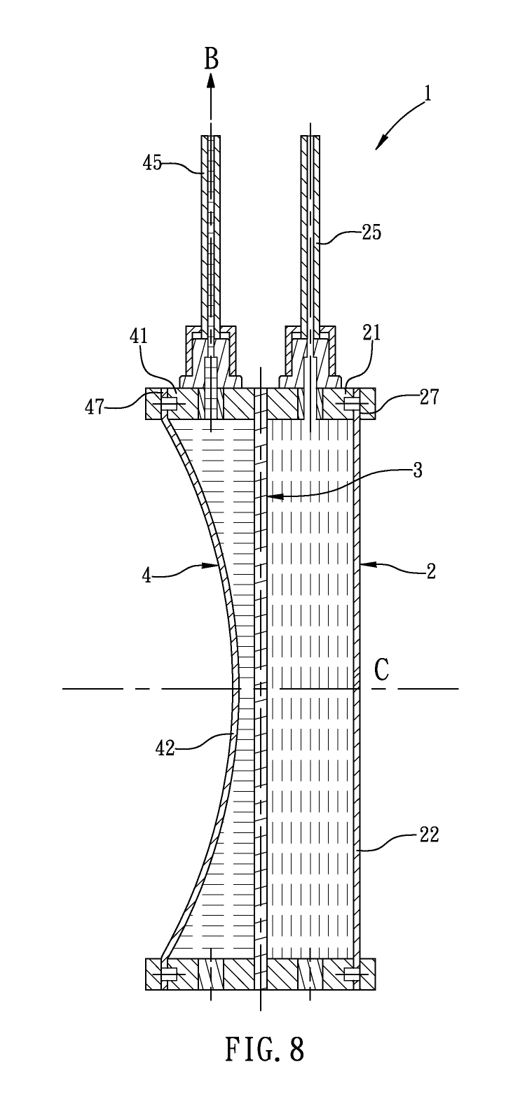

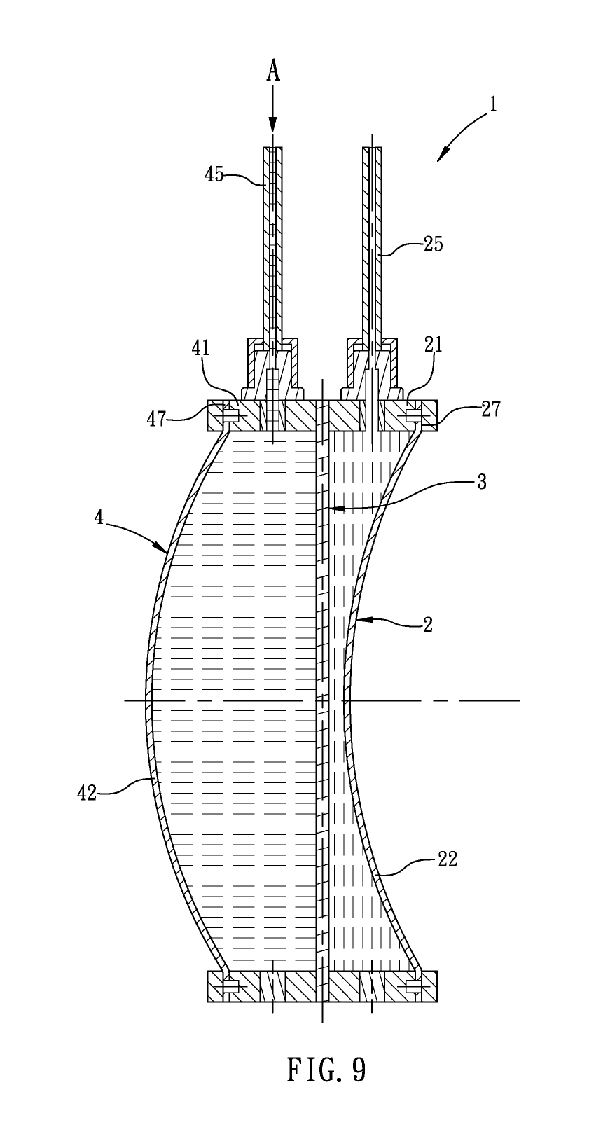

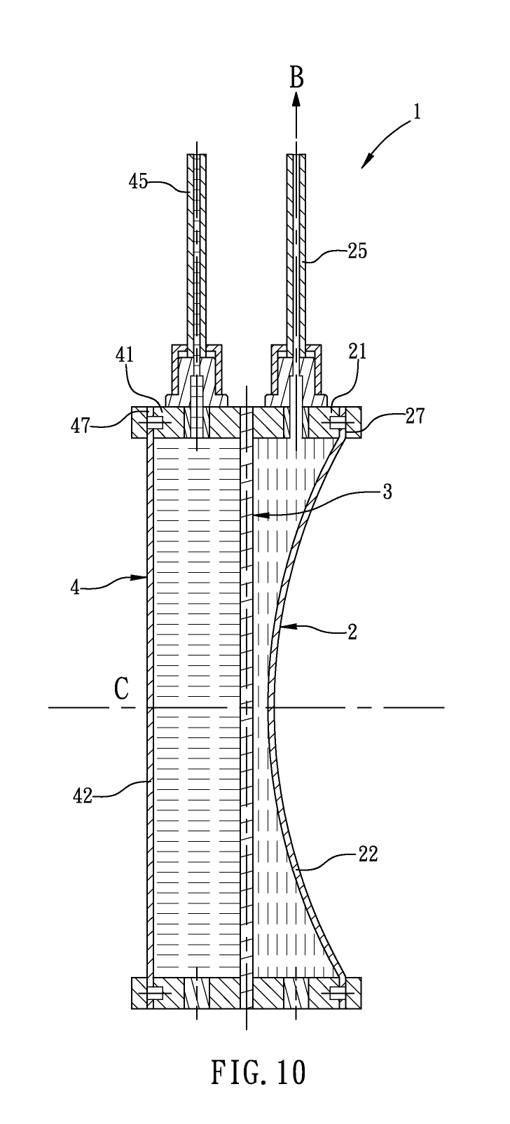

Therefore, through the independent control method of the first and second pressure control units, for the incident light beams in the same direction, the assemble 1 may be formed a convex-convex lens structure (shown as FIG. 3), a flat-convex lens structure (shown as FIG. 4), a concave-convex lens structure (shown as FIG. 5), a convex-flat lens structure (shown as FIG. 6), a flat-flat lens structure (shown as FIG. 7), a concave-flat lens structure (shown as FIG. 8), a convex-concave lens structure (shown as FIG. 9), a flat-concave lens structure (shown as FIG. 10), and a concave-concave lens structure (shown as FIG. 11). Those aforementioned lens structures may be achieved by simple structure, and the focus may be varied to match various equipments, such as a microscope, a telescope, a camera, a video camera, and other optical instruments.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A variable focus flexible lens assembly, comprising:
a first lens module, having a first ring body, a first flexible film, and a first pipe, the first ring body is fluidly communicated with the first pipe, the first flexible film is fixed at one side of the first ring body longitudinally;
a partition plate, disposed at one side of the first ring body of the first lens module far away from the first flexible film, the first ring body, the partition plate, and the first flexible film are defined a first accommodation space which is filled with a first fluid;
a second lens module, having a second ring body, a second flexible film, and a second pipe, the second ring body is fluidly communicated with the second pipe, one side of the second ring body in longitudinal direction is fixed at one side of the partition plate far away from the first lens module, the second flexible film is fixed at one side of the second ring body far away from the partition plate longitudinally, the second ring body, the partition plate, and the second flexible film are defined a second accommodation space which is filled with a second fluid;
a first pressure control unit, connected to the first pipe, the pressure of the first fluid filled in the first accommodation space is controlled by the first pressure control unit independently, and further the curvature of the first flexible film is controlled by the first pressure control unit; and
a second pressure control unit, connected to the second pipe, the pressure of the second fluid filled in the second accommodation space is controlled by the second pressure control unit independently, and further the curvature of the second flexible film is controlled by the second pressure control unit.

2. The variable focus flexible lens assembly as claimed in claim 1, wherein the partition is made of a transparent hard material.

3. The variable focus flexible lens assembly as claimed in claim 1, wherein the first flexible film and the second flexible film are made of an elastic transparent material.

4. The variable focus flexible lens assembly as claimed in claim 1, wherein the first fluid and the second fluid are liquid or gas.

5. The variable focus flexible lens assembly as claimed in claim 4, wherein the first fluid and the second fluid are the same material or different materials.

6. The variable focus flexible lens assembly as claimed in claim 1, wherein the first flexible film and the second flexible film are the same material or different materials.

7. The variable focus flexible lens assembly as claimed in claim 1, wherein the first ring body and the second ring body are with different diameters, and have the same hard material or different hard materials.

8. The variable focus flexible lens assembly as claimed in claim 1, further comprises a first ring frame and a second ring frame, the first flexible film is fixed between the first ring frame and the first ring body, the second flexible film is fixed between the second ring frame and the second ring body, the first flexible film and the second flexible film are fixed by bolts or adhesives.
